(19) United States
(12) Patent Application Publication
(10) Pub. No.: US 2012/0243941 A1
(43) Pub. Date: Sep. 27, 2012

(54) Synthetic Weir Board

(76) Inventor: Carl Anthony Hazenberg, Roswell, GA (US)

(21) Appl. No.: 13/069,525

(22) Filed: Mar. 23, 2011

(51) Int. Cl. E02B 7/00; C08F 110/06; C08F 110/02; C08F 14/06

(52) U.S. Cl. 405/87; 526/344; 526/351; 526/352

(57) ABSTRACT

A synthetic weir board riser system is described that controls the water elevation on the front and rear sides of the structure using synthetic weir boards as the barrier. Weir boards are added and removed from a metallic or composite riser system to control the level of water flowing into a larger body. Synthetic weir boards composed of plastic or composite have an increased life span. Geometrically, the synthetic boards provide a more efficient use of material in terms of weight. A reduced radius per each external corner prevents the increased pressure to the rear of the riser from separating the synthetic boards thereby increasing seepage.

### CROSS REFERENCE TO RELATED APPLICATIONS

### Not Applicable

### STATEMENT REGARDING FEDERALLY SPONSORED RESEARCH AND DEVELOPMENT

### Not Applicable

### REFERENCE TO SEQUENCE LISTING, A TABLE OR A COMPUTER DISC APPENDIX

### Not Applicable

### BACKGROUND OF THE INVENTION

Typical weir boards are timbers that are horizontally stacked within riser structures to regulate water elevations for storm water management applications. By stacking and removing these rectangular or square timbers, water elevations can be controlled before, during and after rainfall events to mitigate flooding. The traditional weir board material, timber, which has a relatively short service life, rots, is eaten by various parasites, warps, twists, splits and is labor intensive to stack and remove because of the density of the boards. Deformations of the boards provide gaps allowing increased seepage and increased surface area for water pressure to act on, further increasing the gap size. Reduction of the geometry by rot and parasitic infestation further reduce the stiffness of the timber boards requiring regular maintenance replacement or increased size of board to allow for sacrificial material loss.

### BRIEF SUMMARY OF THE INVENTION

The synthetic weir board riser system is used to control flow of water/liquid from one body to another through use of synthetic weir boards and a frame support. Synthetic weir boards are placed and removed within the supports to form a physical barrier of variable height to the flow of water/liquid from one body to another, usually a high energy to low energy system. The system uses similar frame supports, constructed from both metallic and composite materials, as prior timber weir board systems. The synthetic weir boards improve on existing art by using a polymer substance as the basis of the weir board. Weir boards constructed from these substances are lighter, less inclined to warp/split and resistant to degradation by parasites thereby extending the service life. The modified geometries of the reduced radius outer corners of the weir boards are such to reduce the migration of water/liquid between boards once a pressure differential occurs.

### BRIEF DESCRIPTION OF THE SEVERAL VIEWS OF THE DRAWING

The accompanying drawings illustrate the invention. In such drawings:

FIG. 1 is a cross-section view of a typical synthetic weir board, showing the general geometry.

FIG. 2 is a section view of the synthetic weir board riser system, illustrating the placement of the weir boards to achieve a differential of water/liquid levels from high to low energy levels.

FIG. 3 is a plan view of the synthetic weir board riser system, illustrating the vertical supports and the way the weir board seats in-between these supports.

FIG. 4 is an elevation view of the high energy side of the synthetic weir board riser system, illustrating how the weir boards appear after placement/removal.

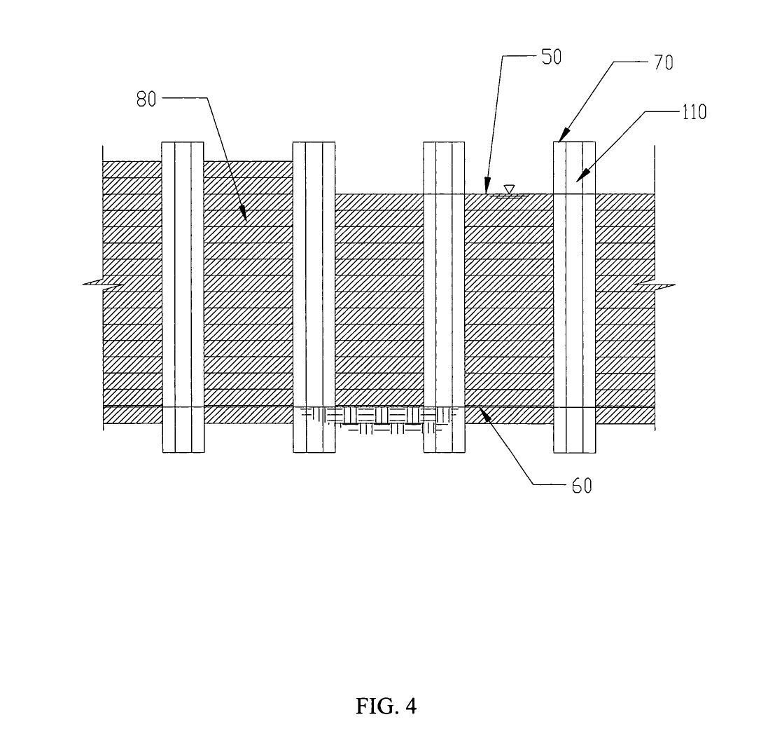

FIG. 5 is an isotropic view of the complete synthetic weir board riser system, illustrating how the weir boards appear after placement to a predetermined level.

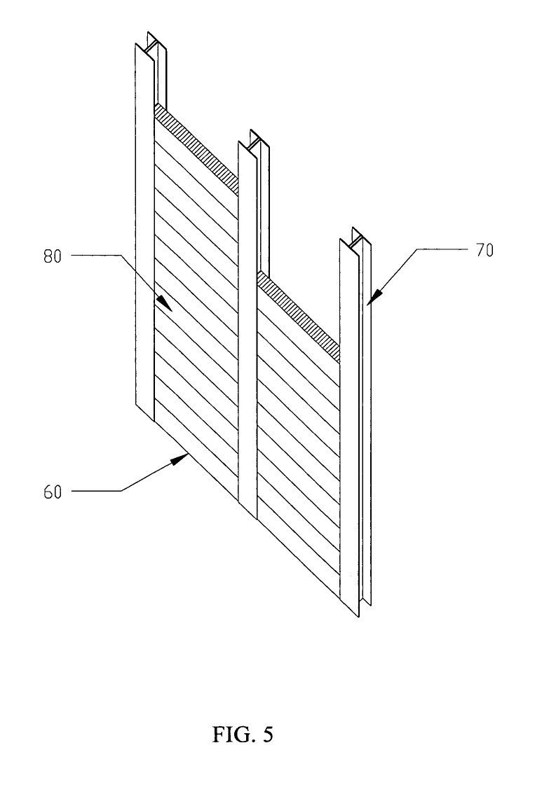

### DETAILED DESCRIPTION OF THE INVENTION

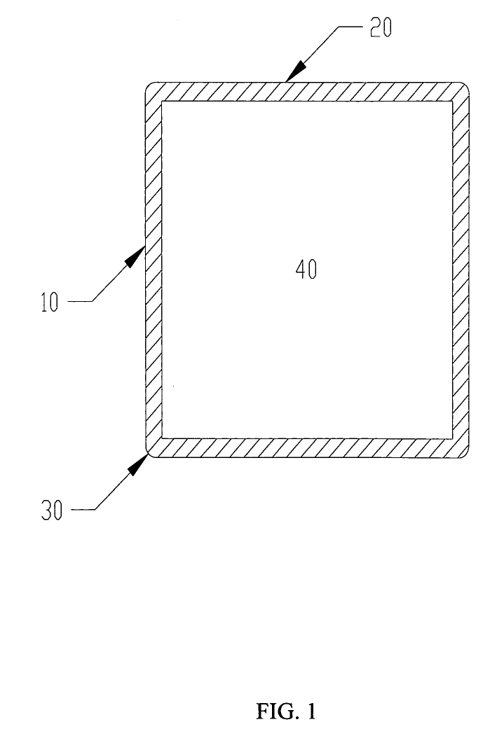

FIG. 1 shows a typical synthetic weir board individual unit with a side wall 10 of varying height and thickness connected to a top wall 20 of varying height and thickness via a 90 degree corner. The top wall 20 is connected to another side wall parallel to side wall 10, with identical dimensions to side wall 10 by another 90 degree corner. Side wall 10 and the identical parallel wall are connected at the bottom of the board by a bottom wall that has identical dimensions to the top wall 20 by 90 degree corners. The varying height and thickness dimensions of the walls 10,20 of the individual boards 80 are dependent on the required structural load they must carry. Wall height and thickness of side walls 10 compared to top and bottom walls 20 are not necessarily identical but are allowed to be. Each outer radius 30 is less than or equal to 0.125 inch. The board also contains a hollow core 40 with similar geometry to the outer surface. The geometry of the hollow core 40 may change as the requirements of the individual weir boards 80 changes.

The synthetic weir boards are constructed from a synthetic substance as a basis such as plastic or composite. Plastics would be considered polymer compounds such as polyvinyl chloride (PVC), polyethylene, polypropylene or similar poly chained compound. Composites would be considered a manufactured product consisting of a fiber matrix encapsulated within a polymer resin. Fibers used in composite would be glass fibers, carbon fibers, aramid fibers or similar used in like fabrication. Polymer resins for composites would be polyester, vinyl ester, polyurethane, epoxy or any combination of these polymers.

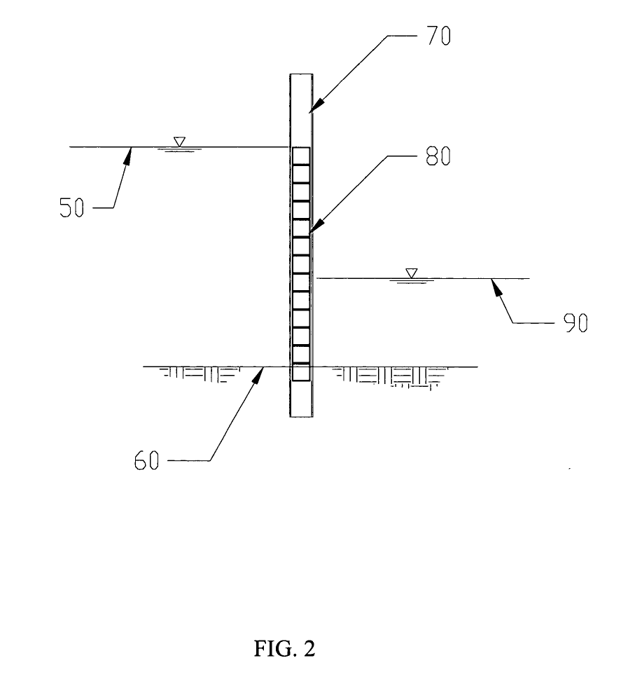

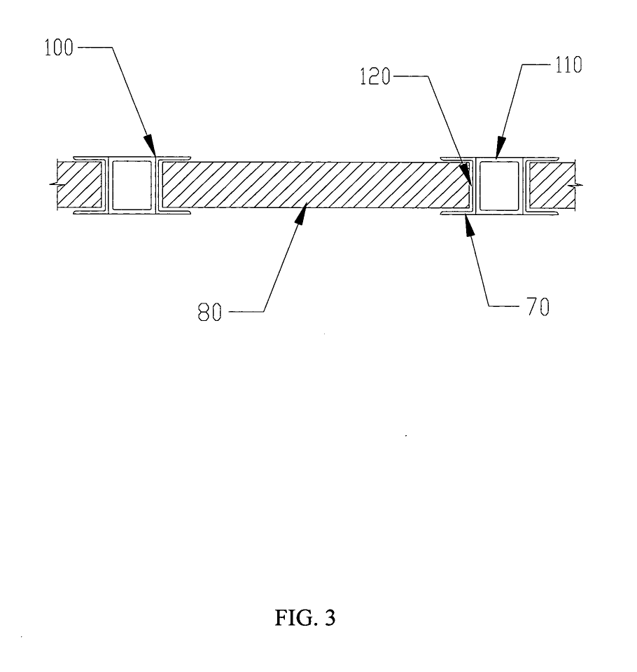

A vertical support system, comprised of a metallic or composite channel 70 and metallic or composite tube 110 welded or mechanically connected at their mating surface 100, two metallic or composite channels connected directly to each other by their mating surfaces or by a metallic or composite I-beam, is driven/inserted into existing grade 60 or a concrete foundation at some predetermined spacing. Individual weir board units 80, oriented horizontally i.e. perpendicular to the vertical supports, are inserted at the top of each pair of vertical supports and allowed to sit on or below grade 60 to form a base. The weir boards 80 are stacked (FIG. 2) until a predetermined upstream/high energy pool water level 50 is achieved. Excess water or other liquid spills over the stacked boards 80 to the downstream/low energy level 90. The flanges of the constraining channels 70 envelop the ends of the individual weir boards 80 to prevent translocation of the boards 80 in a horizontal fashion (FIG. 3). The boards 80 are manufactured/cut into lengths measuring less than the face to face distance of the vertical channels 70 but not less than the distance from end of flange to end of flange. The reduced length will produce a gap 120 to allow water intrusion into the hollow core 40. Pressure differential from the high energy water level 50 to the low energy level 90 will force the weir boards 80 into the inner face of the restraining channels 70, blocking flow of water around the boards 80.

A synthetic system has the advantage of a low coefficient of expansion and water infiltration rate. Less absorption and expansion from both water and thermal inputs reduces the board's 80 likelihood of warping, splitting or otherwise changing the board 80 from its original confirmation. Synthetic boards do not contain substances that are normally consumed/depredated by parasitic organisms. A lack of product wear from biological and natural processes increases the life span of the board 80 beyond a comparable timber board.

The water/liquid differential creates a change in the pressure profile of the front and rear sides of the weir. Increased pressure on the rear side of the weir acts to separate the boards 80 by wedging in-between the boards and forcing the boards to become buoyant. The synthetic boards have a specific gravity in excess of 1.0 allowing for their settlement within the channel. The hollow core 40 further prevents buoyant forces from becoming an issue by allowing air to be replaced by water. The densities are critical in that they prevent the boards from becoming buoyant and creating gaps between boards. The geometry of the boards is such that the radius 30 of each corner is 0.125 inches maximum. A radius 30 of this dimension or smaller provides less open area between boards for the hydrostatic pressure to act on the underside surface lifting the board thereby causing a separation. The weir boards 80 in an individual weir stack may be removed creating a lower elevation than the neighboring stacks. This would create a controlled spillway focusing the water/liquid run over to a designated area.

I claim:

1. Synthetic material has longer service life than timber and is not subject to rot, parasite attack, twisting, warping or splitting.

2. Synthetic materials include, but are not limited to, plastic (polyethylene, polypropylene, polyvinyl chloride), composites (fiberglass, carbon fiber, etc.) or any multiple variation thereof.

3. Hollow geometry provides light weight part which makes it easy to install (stack) and remove.

4. Hollow geometric profile provides for efficient structural strength.

5. Rectangular or square geometric profile provides efficient surface area and width to effectively dam the water.

6. Outside corners of the hollow profile have a radius of 0.125 inches (3.18 mm) or less to minimize seepage of water between the weir boards.
